(19) United States
(12) Patent Application Publication
(10) Pub. No.: US 2014/0207619 A1
(43) Pub. Date: Jul. 24, 2014

(54) System and Method for Multiple Product and Price Discovery

(71) Applicant: Simplex Point Inc., Burnaby (CA)

(72) Inventor: Harold Ishebabi, Burnaby (CA)

(73) Assignee: Simplex Point Inc., Burnaby (CA)

(21) Appl. No.: 14/138,096

(22) Filed: Dec. 22, 2013

Related U.S. Application Data
(60) Provisional application No. 61/756,178, filed on Jan. 24, 2013.

(51) Int. Cl. G06Q 30/06

(52) U.S. Cl. CPC G06Q 30/0623; G06Q 30/0633; G06Q 30/0631; G06Q 30/0639
USPC 705/26.61

(57) ABSTRACT

A system and computer-implemented method are disclosed for optimizing product purchasing to enable consumers to efficiently locate and purchase multiple goods and/or services. A centralized product and price discovery system employs a computer implemented method for determining an optimized purchasing plan using user defined and system defined preferences including the cost of individual products at different locations, product specification differentiation (size, weight, origin of manufacture, user rating), and the cost and/or time to obtain the products from those locations. The optimized plan depends on such factors as the type of transportation employed or the desired maximum distance to be traveled to obtain all the products. The system also improves a vendor's ability to understand the purchasing behaviour of consumers (by region, interests etc.) including the current demand, pricing and frequency of purchases and the type of products being purchased together.

This application claims the benefit of U.S. provisional patent application Ser. No. 61/756,178, filed on Jan. 24, 2013, which is incorporated by reference herein in its entirety.

### FIELD OF THE INVENTION

The present invention pertains to the field of product discrimination and pricing determination systems.

### BACKGROUND

Consumers today have various tools at their disposal to locate goods and services. In many cases, they are interested in comparing various offerings, not only in terms of quality, but also in terms of location and pricing. There is no single solution that enables consumers to efficiently locate and purchase multiple products.

Currently there are a great number of websites and services a consumer may employ in the purchasing of a good or service. There are individual vendor websites, listing services, and price comparison services. Vendor websites list products, but require the consumer to know about the vendor beforehand. Listing services (including advertising services both online and in paper form) allow consumers to locate products, but do not optimize a consumer's needs and preferences to make recommendations or help a consumer achieve an overall cost efficiency. Price comparison services allow consumers to compare offerings from multiple vendors. However, if the consumer needs to buy several items, while optimizing their overall costs for instance, they need to have the time and knowledge to compute the optimum selection of products from the vendors provided. With the great number of choices that are now often available to a consumer, determining an optimal manner of purchasing such products becomes extremely difficult if not impossible to compute.

Other services that can be useful in assisting a consumer in the decision making process are rating services through ratings and direct product recommendations; and coupon services that attempt to achieve a lower purchasing cost for specific products through discounts (for instance, by way of promotions, or bulk purchases). While these services can be useful to a consumer they do not provide any optimizations that aid in the decision process for the consumer buying multiple products.

Search engines allow consumers to locate products without having to know vendors, and they often display rating and navigational instructions as well; however search engines do not compute optimum decisions for a consumer.

There are also savvy shoppers who often attempt to manually visit and compare prices between vendors. Overtime, they may determine the optimum time and way to purchase such products if they repeatedly purchase the same products. However, if the product mix changes, or if prices change, they are unable to make optimum decisions because of a lack of information.

There are commercial and open source optimization software packages suitable for making optimized decisions. However their utility to the general consumer is limited because 1) they require expertise in their usage (both mathematical, and in the manner in which the user interacts with the software package; either through a dedicated interface, or through a specialized programming language) and 2) they lack an integrated listing service so their usage for optimizing a consumer's purchasing decisions is tedious. Only expert users of optimization software packages with lots of time on their hands to program and to manually input product availability and vendor locations are able to optimize their purchasing decisions using such software packages.

On the vendor side, there are various options for managing inventory including proprietary and third party inventory management software. These are usually specific to each vendor.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

A system is needed that integrates optimization software with multiple vendor and product listings and a simplified user interface to enable any consumer to quickly make decisions without the need to know anything about the actual optimization software or algorithms involved. A Product-Price Discovery System (PPDS) is disclosed for improving a consumer's experience of locating multiple goods and services and using an optimizing system that employs user defined preferences and system defined preferences to determine an optimized purchasing solution for the consumer.

Disclosed herein is a product price discrimination system for optimizing product purchasing, comprising a network; a server in communication with the network; and a database connected to the server; the database server storing product pricing information and vendor location information. The server is configured to: receive, from a consumer device connected to the network, an indication of a plurality of products a consumer wishes to purchase; receive a location associated with the consumer; identify, for each product, at least one vendor from which the respective product of the plurality of products can be purchased; compute, based on the vendor location information and the location associated with the consumer, an optimized selection of vendors from the identified vendors for purchasing the plurality of products; and communicate said optimized selection of vendors to the consumer device.

Also disclosed is a computer readable medium for optimizing product purchasing to enable a consumer to efficiently locate and purchase multiple products, the medium comprising computer readable instructions, which, when executed by one or more processors cause the one or more processors to: receive, from a consumer device connected to a network, an indication of a plurality of products a consumer wishes to purchase; receive a location associated with the consumer; identify, for each product, at least one vendor from which the respective product of the plurality of products can be purchased; compute, based on each vendor location and the location associated with the consumer, an optimized selection of vendors from the identified vendors for purchasing the plurality of products; and communicate said optimized selection of vendors to the consumer device.

Still further disclosed is a computer implemented method for optimizing the purchasing of multiple products, the method comprising: receiving, by a processor, a request from a consumer for more than one product, said request containing a first product description and a second product description; receiving, by the processor, a location associated with the consumer; determining, by the processor, qualifying vendors each having an available product that matches a product description within said request; compiling, by the processor, a group of said qualifying vendors, locations of said qualifying vendors, each requested product available at each of said qualifying vendors, and a vendor price for each requested product; determining, by the processor, distances between each of said qualifying vendor locations and said location associated with the consumer, and between each pair of qualifying vendor locations; determining, by the processor, one or more possible routes to obtain all of the requested products; associating, by the processor, a travel cost with each possible route; determining, by the processor, a route that optimizes purchase of all the requested products; and communicating, by the processor, the route that optimizes the purchase of all the requested products to one or more of the consumer and a delivery service.

Further in accordance with the present invention, a PPDS is disclosed for improving a vendor's ability to understand the purchasing behaviour of consumers (by region, interests etc.) including the real time demand, pricing and frequency of purchases as well as the type of products being purchased together.

Further in accordance with the present invention, a PPDS is disclosed for determining an optimized purchasing plan using user defined and system defined preferences including the cost of individual products at different locations, product specification differentiation (size, weight, color, product-specific attributes, origin of manufacture, user rating, etc.), and the cost to obtain the products at those locations, depending on such factors as the type of transportation employed and the maximum desired distance between the origination and final destination of the consumer to obtain all the products, taking into account the time of day and/or delivery/pick up time.

Further in accordance with the present invention, a PPDS is disclosed for determining an optimized purchasing plan using user defined and system defined preferences including product pricing as a function of time, using historical, current and predictive pricing.

Having a system that has the ability to communicate with individual vendor systems to determine the available inventory is invaluable not only to consumers but also to vendors. A centralized product and price discovery system can indirectly expose vendor inventory along with different pricing options to a consumer. Also, such a system can assist vendors in managing their inventory and pricing by providing business intelligence including real time statistics that are not otherwise available, including 1) demand of specific products (not just by store, but also region wide); 2) pricing differences; and 3) purchasing behaviour on which products are bought together, and which products are bought with what frequency.

### BRIEF DESCRIPTION OF THE DRAWINGS

The drawings illustrate aspects of the invention, and should not be construed as restricting the scope of the invention in any way. Drawings are not to scale.

FIG. 1 is a schematic diagram of an exemplary PPDS architecture configuration showing data processing modules and directional flow of data between consumer and vendor users and the PPDS.

FIG. 2 shows an exemplary use optimization problem for computing travel cost between locations.

FIG. 3 is a flow diagram illustrating an exemplary method for determining an optimized purchasing plan.

### DETAILED DESCRIPTION OF THE INVENTION

### Definitions

The term “products,” refers to both goods and services herein for simplicity, and may also be referred to as items. A product may refer to anything that a vendor or other supplier provides to a consumer in exchange, in whole or in part, for money or something having monetary value provided by the consumer to the vendor.

The terms “user,” “consumer,” and “vendor” are used in context to describe the association of a person with the PPDS, a device and the network and may in some cases be the same person. A consumer may be an individual, a group of individuals, a corporate buyer, a charitable organization, or any other consuming entity or representative thereof that obtains a product from a vendor in exchange for consideration.

The term “vendor location” may refer to a point of sales, such as a brick and mortar retail outlet, a vendor's warehouse, a manufacturer's premises, a pick-up point, or any other physical location from where a product may be obtained.

The term “preferences” refers to user defined features of the invention including settings that are adjustable by consumers, vendors, systems operators, or automatically by analysis systems, and can include adjustments made on a real-time basis or based on historical use.

The term “consumer identified location” refers to a location associated with the consumer. It can refer to the location of a consumer, such as the consumer's home, temporary place of residence, place of work, place where visiting, vacation location or any current location. Such location may be identified by the consumer from a pull-down list, or identified automatically by a GPS device. It is also possible to enter the address or coordinates, use 3^{rd} party services to determine the location, use other technologies such as cellular or Wi-Fi triangulation. It is to be understood to be the location from which a consumer starts the trip to the one or more vendors from which the multiple products are to be obtained. By default, the consumer identified location is also the location at which the trip to obtain the products ends. However, this end location may be specified by the consumer to be a different location, which would be applicable if the consumer is purchasing the products en route to another destination.

The term “network” can include both a mobile network and data network without limiting the terms meaning, and includes the use of wireless (2G, 3G, 4G, WiFi, WiMAX, Wireless USB, Zigbee, Bluetooth and satellite), and/or hard wired connections such as internet, ADSL, DSL, cable modem, T1, T3, fibre, dial-up modem, and may include connections to flash memory data cards and/or USB memory sticks where appropriate. A network could also mean dedicated connections between computing devices and electronic components, such as buses for intra-chip communications.

The term “module” can refer to any component in this invention and its network and to any or all of the features of the invention without limitation.

The term “server” is used to refer to any computing device, or group of devices, that provide the functions described herein as being provided by one or more servers.

The term “processor” is used to refer to any electronic circuit or group of circuits that perform calculations, and may include, for example, single or multicore processors, an ASIC, and dedicated circuits implemented, for example, on a reconfigurable device such as an FPGA.

The term “database” refers to both persistent and volatile means of storing information suitable for performing computing functions such as searching, inserting and updating. Typically, these are relational databases such as in MySQL. It is also possible to use no-SQL databases, in-memory data structures, plain computer files or any other means of storing data. A database may be a parallel system database in which the processors are tightly coupled and constitute a single database system or may be a distributed database in which storage devices are not all attached to a common processing unit such as a CPU, and is controlled by a distributed database management system. A distributed database system may be stored in multiple computers, located in the same physical location; or may be dispersed over a network of interconnected computers.

The term “hardware” includes, but is not limited to, the physical housing for a computer as well as the display screen, connectors, wiring, circuit boards having processor and memory units, power supply, and other electrical components. It could also be a system on chip, or system on package.

The term “software” includes, but is not limited to, program code that performs the computations necessary for calculating and optimizing user inputs, the reporting and analysis of product specific data, displaying information, and, managing of input and output data. Software can be both internal to the PPDS and external, i.e. consumer and vendor systems, and a combination of multiple systems.

The term “firmware” includes, but is not limited to, program code and data used to control and manage the interactions between the various modules of the system. Firmware persistently stores updatable processor readable instructions and data, which may be used for part of the PPDS.

The detailed descriptions within are presented largely in terms of methods or processes, symbolic representations of operations, functionalities and features of the invention. These method descriptions and representations are the means used by those skilled in the art to most effectively convey the substance of their work to others skilled in the art. A software implemented method or process is here, and generally, conceived to be a self-consistent sequence of steps leading to a desired result. These steps involve physical manipulations of physical quantities. Often, but not necessarily, these quantities take the form of electrical or magnetic signals capable of being stored, transferred, combined, compared, and otherwise manipulated. It will be further appreciated that the line between hardware, software and firmware is not always sharp, it being understood by those skilled in the art that software implemented processes may be embodied in hardware, firmware, or software, in the form of coded instructions such as in microcode and/or in stored programming instructions.

All of the methods and processes described herein may be embodied in, and fully automated via, software code modules executed by one or more computing devices. The code modules may be stored in any type(s) of computer-readable media or other computer storage system or device (e.g., hard disk drives, solid state memories, etc.). The methods may alternatively be embodied partly or wholly in specialized computer hardware, such as ASIC or FPGA circuitry. The results of the disclosed methods and tasks may be persistently stored by transforming physical storage devices, such as solid state memory chips and/or magnetic disks, into a different state.

In general, unless otherwise indicated, singular elements may be in the plural and vice versa with no loss of generality. The use of the masculine can refer to masculine, feminine or both.

The present description is of the best presently contemplated mode of carrying out the subject matter disclosed and claimed herein. The description is made for the purpose of illustrating the general principles of the subject matter and not to be taken in a limiting sense; the subject matter can find utility in a variety of implementations without departing from the scope of the disclosure made, as will be apparent to those of skill in the art from an understanding of the principles that underlie the subject matter.

The present invention provides a PPDS for the analysis and optimization of the purchase of multiple products and services. The system includes hardware and software, and/or firmware for managing a rule based system that incorporates individual user defined preferences and user preference patterns for specific fields, such as region, product type, product country of origin, user rating, price range, location, etc. A use pattern can be transferred from one individual user to another or be shared to assist with reducing the number of selective preferences. User preference patterns and product grouping patterns can be assigned to geospatial regions and be used for comparative analysis and to improve efficiency within the system.

### Consumer Side of PPDS

In many cases, consumers are interested in comparing various offerings, not only in terms of quality, but also in terms of pricing. The PPDS is a technology that improves on that experience. The PPDS provides an interface through which consumers can enter a description of multiple items (products) they are interested in, together with a general location or a specific address such as a home or office.

The PPDS then uses that information to first locate which vendors carry or offer the products specified by the consumer. This is done in consideration of various product attributes or preferences the consumer has specified (if any), such as quality, price range, origin, service level, vendor/product reputation, and user rating. Secondly the PPDS then determines the distances between locations of the qualifying vendors determined in the first instance by the consumer selected preferences, and the location of the general area or address specified by the user. Such distances may be determined by computation by the processor, or by the processor reading previously computed distances, or by reading them from another source. The PPDS then computes the total cost of purchasing each of the products at each of the locations. The total cost is the actual price offered by the vendor, as well as optionally the cost of getting the product; for instance, using a delivery service, private vehicle, or public transit. The PPDS then performs optimizations to determine the best (i.e. the most cost or time effective way, within optional constraints) of getting all the desired products. In the optimization process, the emphasis is placed on the total combined cost of acquiring the products. The results are then displayed back to the user.

The consumer can view the optimized solution of purchasing the products. The solution consists of instructions on where to obtain the products. The solution optionally includes an optimal sequence of obtaining the products and optionally an optimal route to take to obtain them. In some cases, it is expected that the consumer will accept whatever optimization solution the PPDS produces, without reviewing it, which may be the case, for example, if the consumer requires all products to be obtained using a delivery service.

The user can additionally modify any of the attributes of the product or user preferences at any time during the process in order to review and compare various individual and total price points.

Finally, the consumer can either reserve or order the product; or print, store or share the instructions. Optionally, the consumer can follow detailed routing or navigating instructions to get to the location(s).

Once at a location, the consumer can either pick up a pre-reserved product, or use PPDS instructions to determine where the product can be found, for instance, an aisle in a store, or use PPDS indoor navigation to navigate to the precise location (such as an aisle in a store).

### Vendor Side of PPDS

The PPDS offers vendors the ability to enter the products carried (together with their attributes, quantity, and pricing) and specify promotions, (bulk) discounts, or sales, either at present or a future date. The PPDS uses this information to determine if it would be more cost efficient to obtain some or all of the products the consumer wants presently or at a future date in order to take advantage of lower pricing. The possibility of future cost savings can then be conveyed to the consumer. Also, if there are bulk/volume/group discounts, the PPDS can inform the consumer and give the consumer the option to aggregate their order with those of other consumers, or alert friends/family/colleagues such that they can purchase together.

The PPDS also gives vendors the ability to track the amount and price of sales; compare pricing with other vendors, either in the same area or region, or compare different areas and regions; determine historical purchases to be able to appropriately respond to demand; view predictions about current and future demands; track product requisition and returns; and track consumer satisfaction.

Both consumer and vendor interfaces can either be web interfaces, or a native applications running on devices such as a personal computer, smart phone, or tablet. The core purpose of the PPDS is to increase efficiency, both market efficiency by providing business/market intelligence, as well as cost efficiency from a consumer's perspective. The PPDS assembles together various technologies in a unique way to provide these capabilities.

### Exemplary PPDS Architecture Configuration

The architecture for an exemplary PPDS comprises one or more devices which provide interfaces to consumer and vendor users, as well as backend functionality which includes optimization data processing, data storage, data presentation, and data manipulation capabilities among others. In a typical configuration, the devices are microprocessor based machines which execute software, such as personal computers, servers, smart phones, or tablets.

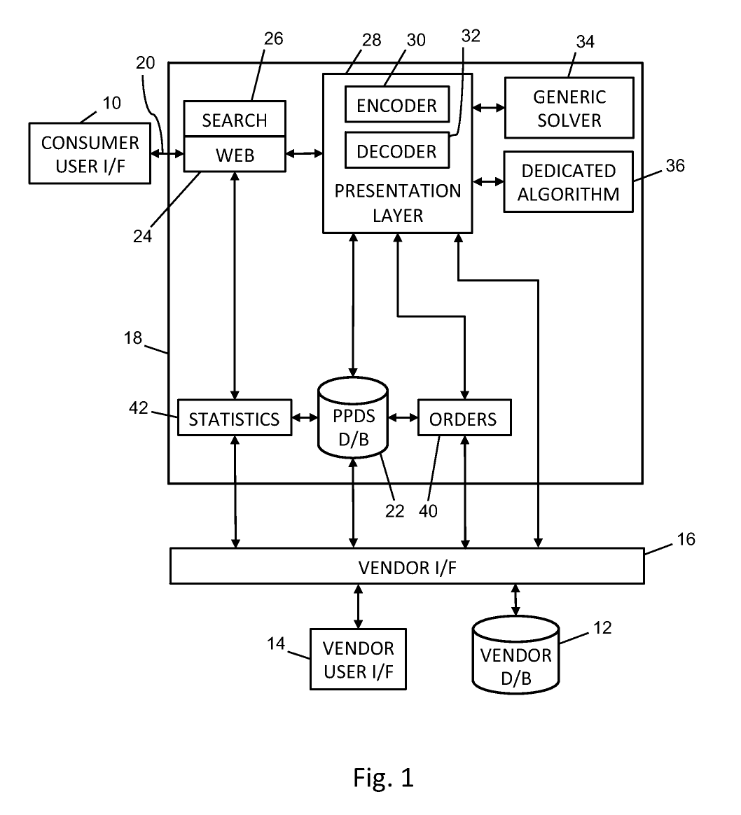

FIG. 1 shows an example of a PPDS configuration. The arrows shown between the consumer user interface 10, vendor modules (12, 14, 16) and within the PPDS backend 18 are all representative of the bidirectional flow of data between processing modules. The processing modules make up a software package required to perform the disparate processing functions of each module. The individual modules that make up the PPDS backend 18 may be on separate servers with their own hardware, memory and software in communication with each other or two or more may be part of a single server or a combination of servers.

Still referring to FIG. 1, a consumer operated device (i.e. consumer device) provides a consumer user interface 10 to a consumer; for instance, via a web-browser or a native application running on a personal computer, tablet or smart phone. The device communicates with the PPDS backend 18 via a network or other medium 20, for example, the internet. The consumer device may be owned by the consumer, it may be a device used by the consumer, or a device used by a representative of the consumer, for example, if the consumer is a business or a manufacturing company that wants to purchase supplies.

The consumer user interface 10 presents to the user one of or both of the following: 1) an organized category from which the consumer can select or specify products and/or their attributes; and 2) a mechanism for inputting search strings or expressions, for example, “sun glass.” One example of an organized category is a collection of menus and/or check boxes as in any typical graphical user interface. This information is obtained either from a PPDS database 22 or vendor database 12 via a module 24 which can be a web server, application server or middleware. A typical example of obtaining this information is through a combination of internet protocols (such as HTTP requests) and standard database queries.

A search engine 26 then processes the user entered information to return found products to the consumer. The information that is returned to the consumer is obtained from a PPDS database 22 and/or one or more vendor database(s) 12. A search engine 26 can be a stand alone module, for instance, a semantic search engine, or it can be part of a standard database query mechanism.

Additionally, the consumer operated device is used to obtain a consumer's desired location, such as an address, or a generic location. This could either be through direct address entry, selection from a menu, or by automated means through the consumer operated device's geo-location capabilities such as its GPS features.

Backend 18 is typically on an application server or web server, implemented using one of a standard of technologies such as server side scripting languages or traditional programming languages such as Java™. The module 18 comprises the presentation layer 28 for obtaining, inserting or updating database information, and for presenting the optimization problem at hand, as well as obtaining its solution.

The presentation layer 28 is comprised of 1) a collection of inter-module communication interfaces (such as one or more Application Programming Interfaces (API), files or memory objects, and/or generic protocols such as TCP/IP); 2) a problem encoder module 30; and 3) a solution decoder module 32. The problem encoder module 30 of the presentation layer 28 converts database or in-memory information into a form that can be processed by either a generic solver engine 34 or a dedicated algorithm implementation module 36. In the exemplary PPDS architecture configuration shown in FIG. 1, the form of the information is a computable readable representation of an abstract mathematical optimization problem. The presentation layer 28 also includes a solution decoder module 32 for performing the reverse operation of the problem encoder module 30: i.e. it obtains a computer readable solution of the abstract mathematical problem from either the generic solver engine module 34 or dedicated algorithm implementation module 36, and converts it into a form suitable for database storage and presentation to a consumer device via the web server, application server or middleware module 24.

For example, a consumer specifies through a consumer user interface 10 a list of products, together with their attributes. A combination of a product (e.g. “sun glasses”) and its user preferred attributes (e.g. “round”, “Chinese-made”) is considered a single item. The presentation layer 28 then obtains from one of or a combination of PPDS database 22 and vendor database(s) 12 the price information for each specified item for each vendor. This information is then used to obtain candidate vendor locations from which to buy each item. In some embodiments, vendor locations may be manually entered, if necessary. Further, the presentation layer 28 either computes the distances between the candidate vendor locations, or obtains the pre-computed information which is stored in PPDS database 22. A full calculation requires determining the distances from each candidate vendor location to every other candidate vendor location. Additionally, distances between the consumer identified location (or as obtained from geo-location capability of the consumer user device) and each of the candidate vendor locations is computed.

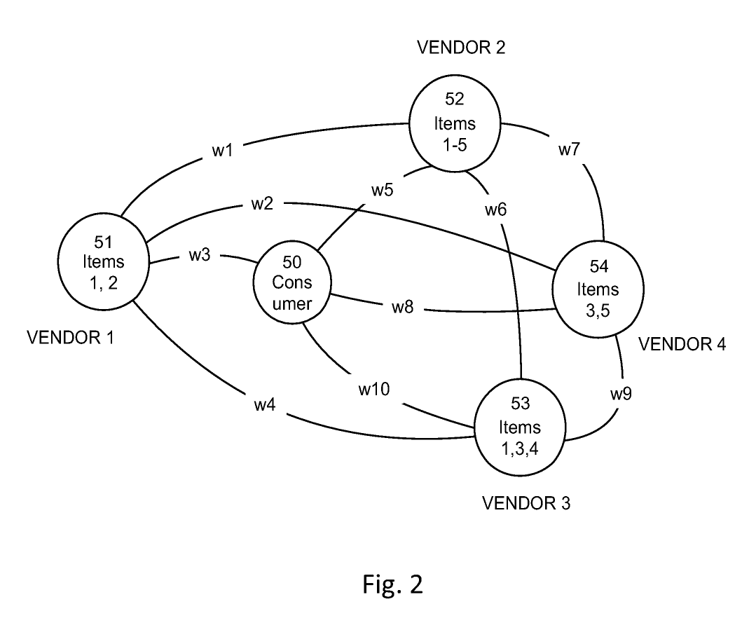

These distances are then used to compute the travel cost, if any, between the locations depending on the mode of travel specified by the consumer (for instance, public transit, walking, cycling, type of specific car, delivery service, etc). For example, the travel cost may be a predetermined, configurable amount per unit distance travelled, multiplied by the total distance the consumer needs to travel to obtain all the products. In other cases, the cost of public transport may be taken into account. In still other cases, a component of or the whole cost of travel may be based on the total time estimated for the trip multiplied by a cost per unit time. The problem can be represented as a graph, which is shown in FIG. 2.

Optionally, still referring to FIG. 1, a consumer can reserve, order, or pre-pay for items directly online. In that case, the order handling module 40 updates the databases, processes payments (or delegates payment processing to another software not part of the PPDS backend 18. The order module 40 then forwards order information to the vendor interface module 16 for the vendor to prepare the order.

The databases 12, 22 store information on products, stock, pricing, discounts, product attributes, statistics, and other management information such as user accounts and billing. The PPDS backend 18 maintains its own database 22. Additionally, vendors can maintain their own databases 12, typically, in conjunction with, or as part of, an inventory or order/sales management software. If a vendor does not maintain their own database, they use the PPDS database 22.

The statistics engine module 42 is the central piece for providing business intelligence. It uses information stored in the databases 12, 22 by other modules to derive additional information and to present that information to consumers and vendors. The information may include 1) amounts and prices of various products sold; 2) price differentials; 3) historical purchases; 4) products purchased together or at the same time; 5) product and/or vendor ratings; 6) rate and frequencies at which items are being sold; and 7) items desired by consumers, but not carried by a vendor.

On the vendor side, a vendor user interface 14 and vendor database(s) 12 communicate with the PPDS backend 18 via vendor interface module 16. The vendor interface module 16 depends on software configuration at a vendor's location. For example, if a vendor is using an inventory or order/sales management software, this software is vendor interface module 16. The manner in which the PPDS backend 18 communicates with a vendor interface module 16 then is fully specified by vendor interface module 16 either through generic protocols, or through proprietary protocols or APIs. In the absence of a management software, the interface is simply a direct connection to a vendor's database 12 if available, and to a vendor user interface 14 running on vendor user's device. TCP/IP can be used in such instances.

The vendor user's device provides a user interface 14 to the vendor in a similar manner to the consumer's user device. The vendor can use information from the PPDS backend 18 for performing activities such as updating stocks, view pricing and statistics, and processing or preparing orders.

### Exemplary Problem

Referring to FIG. 2, an exemplary optimization problem is shown. In graph theoretical terms, each location is a node, and a path of getting from one location or node to the other is represented as an edge. In FIG. 2 the center node 50 represents a consumer's location and the outer nodes represent vendor locations with each vendor showing which of five queried items they have available and their price. Vendor 1 is represented by node 51 and has items 1 and 2 for sale. Vendor 2 is represented by node 52 and has all 5 items for sale. Vendor 3 is represented by node 53 and has items 1, 3 and 4 for sale. Vendor 4 is represented by node 54 and has items 3 and 5 for sale. The costs described above are then the edge weights, represented in FIG. 2 as w1-w10 between the nodes. The graph does not need to be a complete graph as shown in FIG. 2. The actual type depends on the physical geographical characteristics of the region in question. Further, it may be computationally advantageous to omit some physically possible edges in order to reduce the size of the problem (either because of memory constraints in the system, or simply to reduce the run time of the solver).

The problem graphically shown in FIG. 2 is then to obtain all 5 items, from a possible four candidate locations while minimizing the combined prices and the sum of the weights of the edges that need to be visited to retrieve the items, and to go back to the original consumer location. Classically, this is a combinatorial optimization problem.

Optionally, the problem can be augmented with additional constraints such as a maximum total travel distance or maximum total time spent retrieving items. For example, for those who have to walk, a maximum total distance to obtain the items may not exceed a certain number, which represents the distance traveled to obtain the items. Another example, for those in a rush, a maximum total time spent to obtain the items may not exceed a certain amount of time, which may include a combination of travel time and time spent in a vendor location. Additionally, the problem is extensible, in order to simultaneously optimize a purchasing solution for multiple buyers, either individually, or in aggregation.

The problem can be solved using a generic engine 34 capable of solving generic combinatorial problems. One such example is the open source software suite Ipsolve™. The actual manner of integrating the solver and the presentation layer 28 depends on the interface exposed by the engine. For automation purposes, as is required here, the interface could be through files, which encode the abstract mathematical problem in a suitable format, or through an API.

It is also possible to solve the problem using a dedicated module 36 which implements an algorithm specifically designed to solve this problem. There are many possible variations of such algorithms. As an example, a simple algorithm could use brute force to systematically enumerate all possible candidates for the solution and then compare all possible combinations.

Once a solution has been obtained, the solution is directed from the generic engine module 34 or dedicated module 36 to solution decoder module 32 which appropriately formats and presents the solution to the consumer through the consumer user interface 10 on the consumer's device. The solution advises the consumer where to buy, when to buy a specific subset of items if there are discounts at later dates, as well as the traveling sequence. Optionally, the web module 24 can also generate and present navigation instructions, or generate a summary of sequences which can then be utilized by the consumer's device to generate and present navigation instructions. The consumer can then print, store, or follow instructions to the vendors. Optionally, delivery instructions can be sent or displayed to a delivery service. A consumer's order may be divided between different delivery services, and each may be provided with its corresponding portion of the route.

### Exemplary Solution

A very simple example can be considered in which only items 3 and 5 are to be bought. The cost of the items is shown in Table 1, these items being available only from vendors 2, 3 and 4 (52, 53, 54 respectively in FIG. 2).

TABLE 1

| Vendor | Item 3 price/$ | Item 5 price/$ |
|---|---|---|
| 2 | 10 | 19 |
| 3 | 5 | n/a |
| 4 | 12 | 16 |

Table 2 shows the weights of the edges between the consumer 50 and the vendors 52, 53, 54. The weights, in their simplest form may be a measurement of the distance of each edge, which would be applicable if the consumer intended visiting the vendors on foot. In this example, the weights used are the distances in kilometres of the edges. Distances would also be suitable weights for driving, provided the cost of driving were determined as a certain price per kilometre multiplied by the distance travelled. However, the costs of toll roads may be included if the vendors are to be visited by car.

TABLE 2

| Edge | Weight |
|---|---|
| w5 | 1 |
| w6 | 5 |
| w7 | 2 |
| w8 | 3 |
| w9 | 6 |
| w10 | 12 |

Now, a consumer who wants to purchase the items 3, 5 by visiting the vendors on foot may set a preference that the total distance should be less than 3 km. In this case, the result produced is that both items must be purchased from vendor 2, as shown in the first result row of Table 3. However, if the preference is set to be less than 8 km, then other options appear as possible purchasing plans, as shown in the last four rows of Table 3. The system would identify the optimum solution as the one with the lowest total cost of the four possible solutions, which would be to buy item 3 from vendor 2 and item 5 from vendor 4. Note that this is a different recommendation to before. Consumers may input more relaxed preferences if they are cycling rather than walking.

TABLE 3

| | Item 3 from | Item 5 from | Total | Total |
|---|---|---|---|---|
| Preference | vendor: | vendor: | weight | cost/$ |
| <3 km | 2 | 2 | 2 | 29 |
| <8 km | 2 | 2 | 2 | 29 |
| <8 km | 2 | 4 | 6 | 26 |
| <8 km | 4 | 2 | 6 | 31 |
| <8 km | 4 | 4 | 6 | 28 |

In another scenario, the user may want to visit the vendors by car. In this case, there is a financial cost associated with each of the edges. To keep the example simple, the cost is $1 per km, which covers fuel and depreciation of the car. The results of calculating the solution to such a problem are shown in Table 4. It can be seen that the total cost of obtaining both items is lowest if both items are purchased from vendor 2, even though the actual cost of the items themselves are lower at the other vendors.

TABLE 4

| Item 3 from | Item 5 from | Total edge | Travel | Cost of | Total |
|---|---|---|---|---|---|
| vendor: | vendor: | weight | cost/$ | items/$ | cost/$ |
| 2 | 2 | 2 | 2 | 29 | 31 |
| 2 | 4 | 6 | 6 | 26 | 32 |
| 4 | 2 | 6 | 6 | 31 | 37 |
| 4 | 4 | 6 | 6 | 28 | 34 |
| 3 | 2 | 18 | 18 | 24 | 42 |
| 3 | 4 | 21 | 21 | 21 | 42 |

To indicate the complexity of the problem at hand, even for such a simple scenario as the one we are considering, the cost per km of traveling by car has now been changed to $0.20/km. This changes the optimum solution provided by the system quite dramatically, as can be seen in Table 5. Here, the optimum solution is to buy item 3 from vendor 3 and item 5 from vendor 4, as shown in the last row of the table.

TABLE 5

| Item 3 from | Item 5 from | Total edge | Travel | Cost of | Total |
|---|---|---|---|---|---|
| vendor: | vendor: | weight | cost/$ | items/$ | cost/$ |
| 2 | 2 | 2 | 0.40 | 29 | 29.40 |
| 2 | 4 | 6 | 1.20 | 26 | 27.20 |
| 4 | 2 | 6 | 1.20 | 31 | 32.20 |
| 4 | 4 | 6 | 1.20 | 28 | 29.20 |
| 3 | 2 | 18 | 3.60 | 24 | 27.60 |
| 3 | 4 | 21 | 4.20 | 21 | 25.20 |

It will be seen that many other factors may be included in the values of the weights. For example, the direction travelled on an edge may lend a different weight to it, for example if a one-way system is to be navigated. The number of left-hand turns may also add to the weight of an edge, and may be different one way compared to the other. The side of the street the vendors are on may impact the weights. The average driving time may also influence the weights of the edges, so that by car the optimum total price of obtaining the items is based on the purchase cost of the items, the cost of travelling and the time taken to complete the trip.

### Flow Diagram

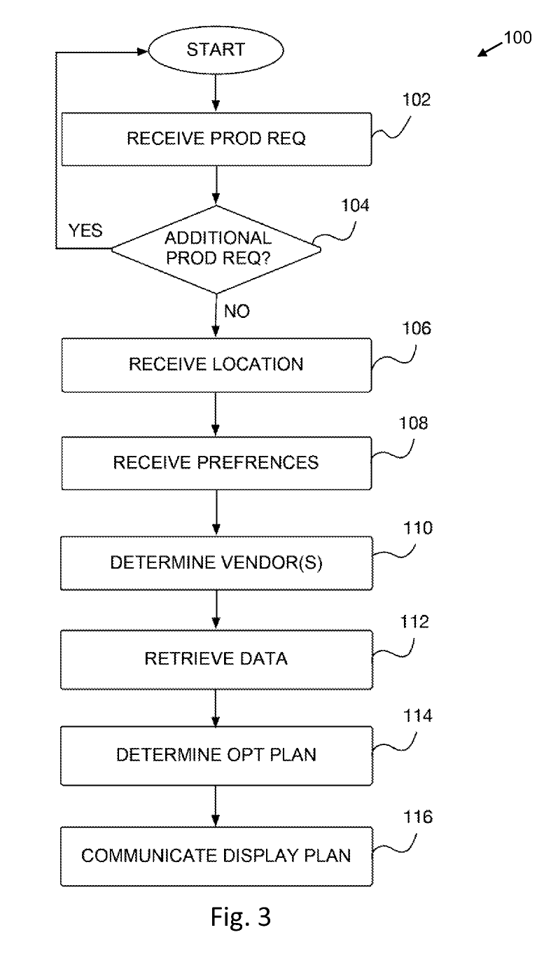

Referring now to the flow diagram of FIG. 3, one exemplary embodiment of an information processing method 100 for processing a consumer's product requests is shown. A consumer's request for a product along with any consumer preferred attributes of the product is received by a PPDS application server (PPDS backend module 24) at step 102. The request may be received directly from a consumer-owned device or another device that the consumer uses, and may originate from a standing order created by the consumer and stored in the PPDS. This processing sequence is repeated via step 104 until a consumer has entered all their desired items. At step 106, consumer identification of a location, for instance a home or work address, is also received by PPDS application server (PPDA backend module 24) and processed. The location may be received from the consumer device, from storage or via other means. For example, the PPDS may already have the location of the consumer stored, and it may have been previously entered by the consumer via any device, or determined by a consumer device or other devices interacting with the consumer device. Next, at step 108 a customer's preferred maximum travel distance and/or preferred mode of travel is also received by PPDS application server (PPDA backend module 24) and processed. The consumer's location and mode of travel can be alternately identified 1) from the customer entering an address and travel mode, 2) from geo-location capabilities of a consumer's interfacing device, and/or 3) from a consumer's default preference data file stored on PPDS database 22. A search engine 26 is utilized to determine which vendors have a qualifying product at step 110. Such determination step may be realized by the processor searching the vendor and product databases, or may be performed by the processor simply reading the qualifying vendors from storage, for example, if a similar search had already been done by the same or a different consumer. Product information may be accessed from either the PPDS database 22 or from individual vendor databases 12. For every vendor with at least one qualifying product, a data string is added to a qualifying list or group at step 112 for problem encoding by the problem encoder 30. A data string contains retrieved data such as the vendor name, location, product description, price (historic, current, future), product origin, product weight, product size, product location, quantity available, store rating and product rating. For any items not available, consumer preferences may optionally be relaxed; for instance the maximum distance preferences may be enlarged or product attributes removed in order to offer possible similar qualifying products for the consumer to review and reject or approve. Relaxation of preferences may be automatic and notified to the consumer, or the extent to which preferences are relaxed may be set as a preference by the consumer. Once a consumer has entered all their desired qualifying items, the problem encoder 30 encodes the resulting accumulated data strings and determines an optimized purchasing plan at step 114 via either the generic solver engine 34 or a dedicated algorithm solver engine 36, with the optimization default being to minimize overall product costs within a defined maximum travel distance. As described above, the optimization plan may use time rather than distance or a combination of the two, to determine an optimized purchasing plan. The optimized product purchasing solution is then decoded at solution decoder 32 and communicated to the consumer as a purchasing sequence plan at step 116 via the application server (PPDS web module 24) to be displayed on a consumer's device via consumer user interface 10. An optional map may be provided to the consumer or a directive link to a navigational application either on the consumer's interfacing device or a navigational application within the PPDS system or a 3^{rd} party platform.

The foregoing embodiments of the invention are examples and can be varied in many ways. For example, steps in the flowchart may be performed in a different order to that shown, certain steps may be omitted or others may be added, while still providing a suitable embodiment of the invention. At least part of the server and part of the network may be integrated in one computing device. The database and the server may be incorporated in the same or different devices. The various databases may be stored in the same or different devices. Any determination step taken by the processor may be undertaken by the processor performing a calculation or by reading data that is stored, either within the PPDS or from an external source.

Such present or future variations are not to be regarded as a departure from the scope of the invention, and all such modifications as are obvious to one skilled in the art are intended to be included within the scope of the following claims.

I claim:

1. A product price discrimination system for optimizing product purchasing, comprising:
a network;
a server in communication with said network;
a database connected to the server; said database server storing product pricing information and vendor location information;
wherein the server is configured to:
receive, from a consumer device connected to the network, an indication of a plurality of products a consumer wishes to purchase;
receive a location associated with the consumer;
identify, for each product, at least one vendor from which the respective product of the plurality of products can be purchased;
compute, based on the vendor location information and the location associated with the consumer, an optimized selection of vendors from the identified vendors for purchasing the plurality of products; and
communicate said optimized selection of vendors to the consumer device.

2. The product price discrimination system of claim 1, wherein the server is configured to compute the optimized selection of vendors further based on a travel cost of the consumer from the location associated with the consumer via the selected vendors back to the location associated with the consumer.

3. The product price discrimination system of claim 2, wherein the travel cost is based on a travel cost per one or more of unit distance and unit time, determined by a mode of transportation selected from the group of public transit, delivery service and private vehicle.

4. The product price discrimination system of claim 1, wherein the server is configured to compute and communicate, to one or more of the consumer device and a delivery service, an optimized order in which the optimized selection of vendors should be visited.

5. The product price discrimination system of claim 2, wherein the optimized selection of vendors is determined by a lowest total cost to obtain said plurality of products taking into account the product pricing information and travel cost.

6. The product price discrimination system of claim 1, wherein said optimized selection of vendors is determined by a lowest calculated time for the consumer to obtain the plurality of products and return to the location associated with the consumer.

7. The product price discrimination system of claim 2, wherein said optimized selection of vendors is determined by a lowest cost to obtain the plurality of products within a user defined maximum total distance travelled to obtain the plurality of products.

8. The product price discrimination system of claim 1, wherein the database stores product descriptions including one or more of size, weight, color, product-specific attributes, origin of manufacture, and user satisfaction ratings.

9. The product price discrimination system of claim 1, wherein the database stores vendor information including: opening hours, user satisfaction ratings, quantity of each available product, and product location.

10. The product price discrimination system of claim 1, wherein the product pricing information includes historic, current and forecasted pricing; and when a historic or forecasted product price is lower than a current price, the server communicates a notification of price difference to the consumer device.

11. The product price discrimination system of claim 1, further comprising
a statistics processing engine in communication with the server and the database;
wherein said statistics processing engine is configured to:
compile information from data stored in the database, said compiled information including one or more of: amounts and prices of each product sold; pricing differentials; historical consumer purchases; product and vendor ratings; rate at which items are being sold; and items requested by consumers which are not carried by a vendor; and
convey said compiled information to one or both of consumers and vendors.

12. The product price discrimination system of claim 9, further comprising an order handling application in communication with the server for reserving, ordering, or pre-paying for products online, or for aggregating orders with one or more other consumers; the order handling application updating the database with the quantity of each available product after items have been ordered, reserved or pre-purchased.

13. The product price discrimination system of claim 12, wherein the server is in communication with a vendor interface module and forwards order information to the vendor interface module.

14. A computer readable medium for optimizing product purchasing to enable a consumer to efficiently locate and purchase multiple products, the medium comprising computer readable instructions, which, when executed by one or more processors cause the one or more processors to:
receive, from a consumer device connected to a network, an indication of a plurality of products a consumer wishes to purchase;
receive a location associated with the consumer;
identify, for each product, at least one vendor from which the respective product of the plurality of products can be purchased;
compute, based on each vendor location and the location associated with the consumer, an optimized selection of vendors from the identified vendors for purchasing the plurality of products; and
communicate said optimized selection of vendors to the consumer device.

15. The computer readable medium of claim 14; wherein, the optimized selection of vendors is determined by a lowest cost to obtain the plurality of products.

16. The computer readable medium of claim 14; wherein, the optimized selection of vendors is determined by a lowest cost to obtain the plurality of products within a maximum travel distance.

17. The computer readable medium of claim 14, further causing the one or more processors to communicate to the consumer device an optimized order in which the optimized selection of vendors should be visited.

18. A computer implemented method for optimizing purchasing of multiple products, the method comprising:
receiving, by a processor, a request from a consumer for more than one product, said request comprising multiple product descriptions;
receiving, by the processor, a location associated with the consumer;
determining, by the processor, qualifying vendors each having an available product that matches a product description within said request;
compiling, by the processor, a group of said qualifying vendors, locations of said qualifying vendors, each requested product available at each of said qualifying vendors, and a vendor price for each requested product;
determining, by the processor, distances between each of said qualifying vendor locations and said location associated with the consumer, and between each pair of qualifying vendor locations;
determining, by the processor, a plurality of possible routes to obtain all of the requested products;
associating, by the processor, a travel cost with each possible route;
determining, by the processor, a route that optimizes purchase of all the requested products; and
communicating, by the processor, the route that optimizes the purchase of all the requested products to one or more of the consumer and a delivery service.

19. The computer implemented method of claim 18; wherein, the optimized route is determined by a lowest cost to obtain all of the requested products, based on the vendor price for each product and the travel cost of each route.

20. The computer program product of claim 18; wherein, the optimized route is determined by a lowest cost to obtain all of the requested products within a maximum travel distance.
